(19) United States
(12) Patent Application Publication
(10) Pub. No.: US 2006/0231542 A1
(43) Pub. Date: Oct. 19, 2006

(54) Connecting device for fixing flat-shaped separation elements

(75) Inventor: Michaela Kienle, Lisboa (PT)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Foremost International GmbH & Co. KG, Bergisch Gladbach (DE)

(21) Appl. No.: 11/404,085

(22) Filed: Apr. 14, 2006

(30) Foreign Application Priority Data
Apr. 15, 2005 (DE) 20 2005 006 152.2

(51) Int. Cl. H05B 3/00; H05B 1/00; H05B 11/00

(52) U.S. Cl. 219/209

(57) ABSTRACT

Connection means for fixing planar partitioning elements to a wall, particularly for shower partitioning elements made of glass or plastic, with a base element that can be fixed to the wall with a fixing surface and a fixing element that stretches transversely to the base element to which the planar partitioning element can be fixed. At least one fastening opening for holding a fixing element is provided in the base element. At least an adjustment opening for receiving an adjusting element is provided in the base element, and the spacing of at least a part of the fixing surface to the wall can be adjusted with said adjusting element.

The invention refers to a connection means for fixing planar partitioning elements to a wall, particularly for fixing shower partitions made of glass, plastic or a similar material. The connection means also preferably serves for fixing shower partition walls made of glass, plastic or a similar material. The wall preferably but not exclusively involves the building wall near a shower cabin or in a bathroom.

Connection means of the above mentioned type are familiar in practice in different embodiments. With these connection elements, particularly glass plates or glass walls are fixed to a wall such that the glass plate or the glass wall is in transverse alignment with the wall. Desirable in this case is an angle of 90° between the wall and the planar partitioning element. The wall to which the planar partitioning element should be fixed is generally not exactly straight or rather not tiled exactly straight, but more-or-less exhibits an inclined orientation. If one would fix the connection means to such an “inclined” wall, without further measures, then the angle between the wall and the planar partitioning element would deviate more-or-less significantly from a 90° -angle. To avoid this, for example in practice, it is common to bend an angular connection means to a certain extent so that an angle of about 90° is attained between the wall and the planar partitioning element. Furthermore, it is familiar to work with shims on the connection means, for example with plastic pads, in order to create a perpendicular configuration of the wall and the planar partitioning element. These measures as already familiar in practice leave a lot to be desired with regard to precision and functional safety.

In contrast, the invention is based on the technical problem to specify a connection means of the type previously mentioned, with which a perpendicular alignment with a wall of a planar partitioning element is adjustable in a simple, functionally safe and precise manner.

To solve this technical problem, the invention instructs about a connection means for fixing planar partitioning elements, particularly for fixing shower partitions made of glass or plastic to a wall,

with a base element that can be fixed to the wall with a fixing surface and a fixing element that stretches transversely to the base element to which the planar partitioning element can be fixed,

wherein at least a fastening opening for holding a fixing element is provided in the base element, and

wherein at least an adjustment opening for holding an adjusting element is provided in the base element, the spacing to the wall of at least a part of the fixing surface can be set with said adjusting element.

As already explained above, the planar partitioning element preferably involves a shower partition wall, which is particularly made of glass or plastic or a comparable material. The planar partitioning elements are arranged with the help of a connection means aligned transversely to the wall. It is within the scope of the invention that the connection means is angular in shape, wherein the base element forms the one leg of the angle and the fixing element forms the other leg of the angle. It lies furthermore within the scope of the invention that the base element and the fixing element form an angle of 90°.

Preferably, the base element is shaped as a base plate, wherein the fastening opening and the adjustment opening penetrate through the base plate. According to the advantageously preferred embodiment, the fastening opening in the base element is designed as a slotted hole in which the fixing element is mounted in a sliding manner. Preferably, the fixing element entails a fixing screw, a fastening screw or similar, wherein the fixing element can be fixed in the wall or preferably in a dowel let in the wall. With the help of the slotted holes, the base element can be adjusted on the wall relative to the fixing element. The longitudinal axis of the slotted hole is advantageously located in a horizontal plane.

According to the advantageously preferred embodiment, which is of special importance within the scope of the invention, the adjustment opening is aligned eccentrically in the base element or rather the adjustment opening is eccentrically aligned in the fixing surface of the base plate. Eccentricity in this case refers to the middle or rather midpoint of the fixing surface. According to the advantageously preferred embodiment of the invention, the adjustment opening features an internal thread, which accommodates an adjusting element shaped as an adjusting screw. The adjusting screw is advantageously screwed in the adjustment opening without clearance. The adjusting screw can then be screwed into the adjustment opening such that it penetrates the adjustment opening and acts on the wall. By further screwing the adjusting screw in the adjustment opening, the spacing between the wall and the fixing surface of base element can be enlarged in the adjustment opening or adjusting screw section. By turning the adjusting screw in the opposite direction, the so-called spacing can be reduced accordingly. The adjusting screw is advantageously made of plastic.

A preferred embodiment of the invention is characterized in that the angle between the fixing element or between the fixing surface provided on the fixing element for the planar partitioning element and at least an area element of the fixing surface of the base element is somewhat smaller than 90°. This area element of the fixing surface lies particularly in the adjustment opening and fastening opening sections. This angle is 95° to 99°, but preferably 96° to 98.5°.

According to a preferred embodiment of the invention a spacer protrudes out of the fixing surface of the base element, which ensures a specified spacing between the fixing surface and the wall in the spacer section. Preferably, the spacer and adjustment opening are separate from one another, thus they are arranged with spacing from one another in different areas of the base element or fixing surface. Preferably, the adjustment opening with the adjusting element is located in the one half of the fixing surface, and the spacer is located in the other half of the fixing surface. According to a preferred embodiment of the invention, adjustment opening and spacer are located on opposite sides of the fastening opening.

It is within the scope of the invention that the fixing element is made as a fixing plate, that a fixing plate is provided and that the fixing plate and fixing plate for a clamping holder of a planar partitioning element are connectable with one another. The fixing plate is advantageously located perpendicular or rather at an angle of 90° to the base plate. Thereby it should be considered that according to a preferred embodiment of the invention, the angle between at least one surface element of the fixing surface of the base element and the fixing plate is somewhat smaller than 90°. This preferred embodiment was already mentioned above. Preferably, the fixing plate and fastening plate can be connected with one another by means of a screw connection. For this purpose, at least a fixing screw is provided, which penetrates though a slotted hole provided in one of the two plates. This fixing screw can be screwed in the threads provided in one of the plates. The longitudinal axis of the slotted hole stretches preferably in longitudinal direction of the fixing plate, this means transverse or rather perpendicular to the base element. With the help of the slotted hole, the fixing plate and fastening plate can be slid relative to one another and in this manner an additional possibility for adjustment is provided. According to a particularly preferred embodiment of the invention, the slotted hole is located in the fixing plate and the fixing screw is provided in this slotted hole. This fixing screw can then be screwed in a thread provided in one of the fixing plates.

Preferably, the fastening opening and the adjustment opening are coverable and preferably also the slotted hole in the fixing element is coverable. According to the advantageously preferred embodiment of the invention a single angular covering element is provided for this purpose, with which the fastening opening, adjustment opening and slotted hole are coverable. The angular covering element is thereby preferably form-closed adaptable in a recess of the connection means.

The base plate and the fixing plate of the connection means preferably consist of metal. Preferably, also the fixing screw and the fastening screw are made of metal.

The invention is based on the understanding that, with the connection means according to the invention, very accurate setting of the angle between a planar partitioning element and a wall is possible. In particular, an angle of exactly 90°can be set between the planar partitioning element and the wall. Particularly, the adjustment opening with the adjusting element contributes to this possibility of effective adjustment. Furthermore, also the slotted-hole as fastening opening contributes to precise adjustment. The inclination of at least one area element of the fixing surface has proven itself. Furthermore, also the slotted hole in the fixing plate contributes to an effective adjustment. The combination of all the preceding features has proven itself in regard to simple, precise and functionally safe setup or adjustment. To be highlighted is moreover that the connection means according to the invention can be manufactured easily and cost effectively.

In the following the invention is described in detail on the basis of an exemplary embodiment that corresponds to the preferred embodiment. The following are schematically depicted:

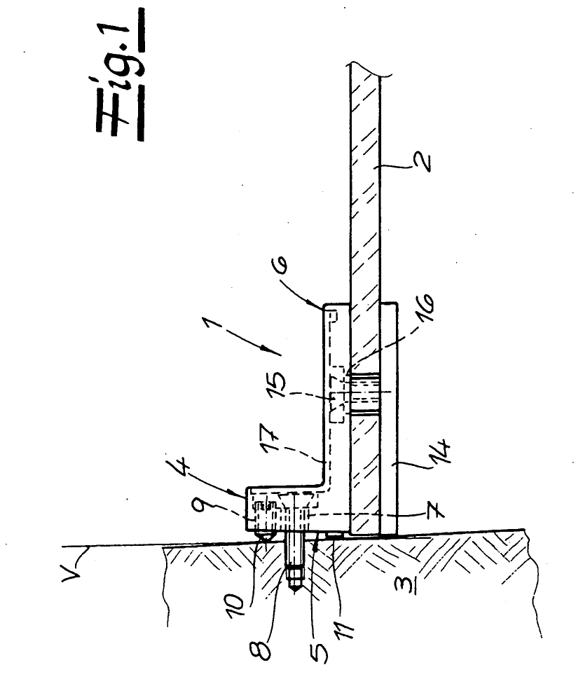

FIG. 1 plan view of a connection means according to the invention fixed to a wall,

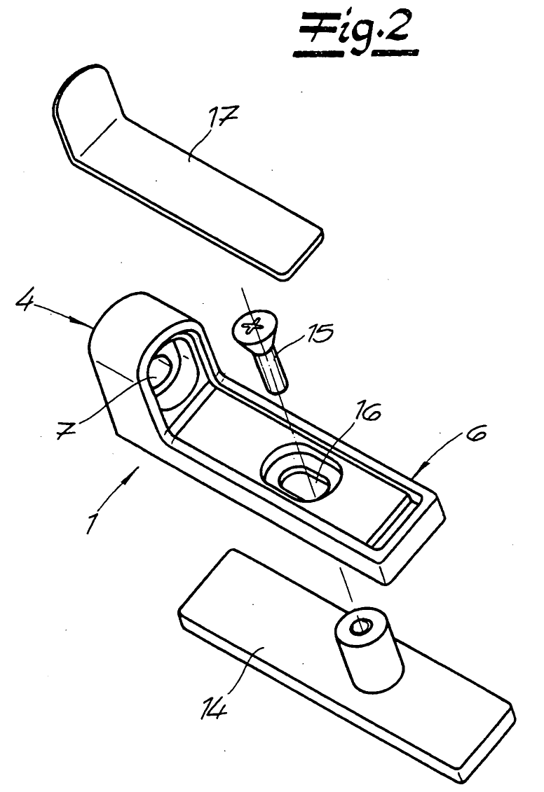

FIG. 2 perspective explosion illustration of the connection means according to the invention,

FIG. 3 sectional view of the connection means according to the invention,

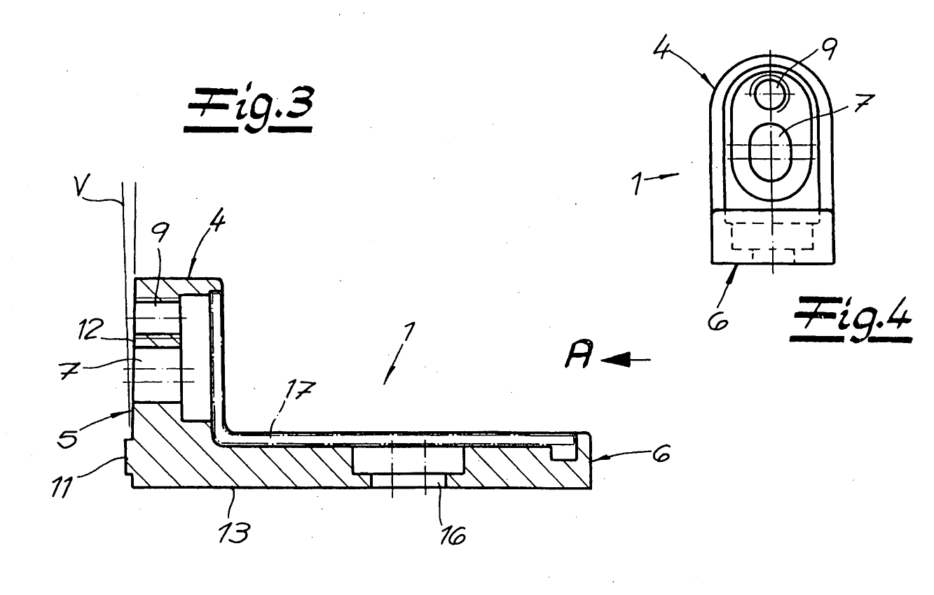

FIG. 4 plan view of the object according to FIG. 3, from the direction of arrow A,

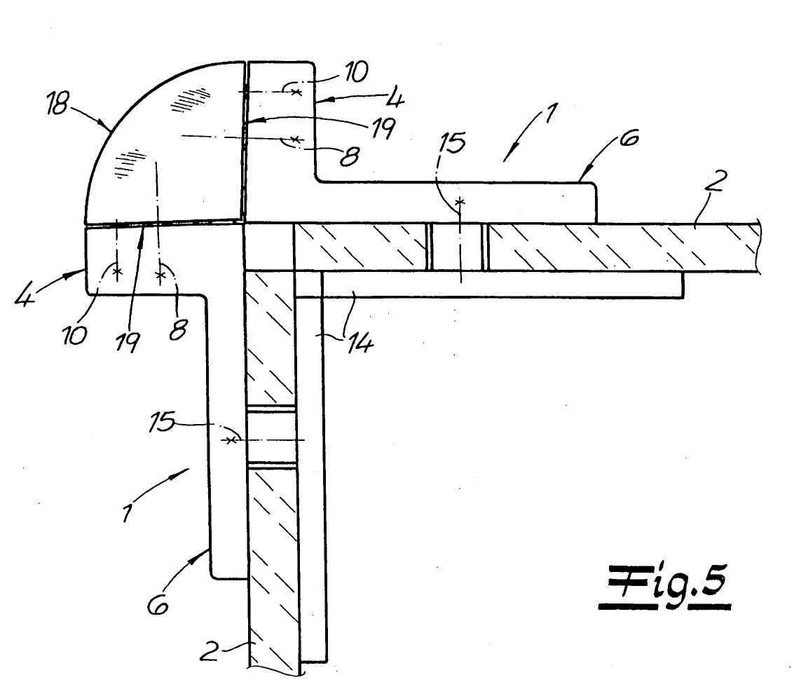

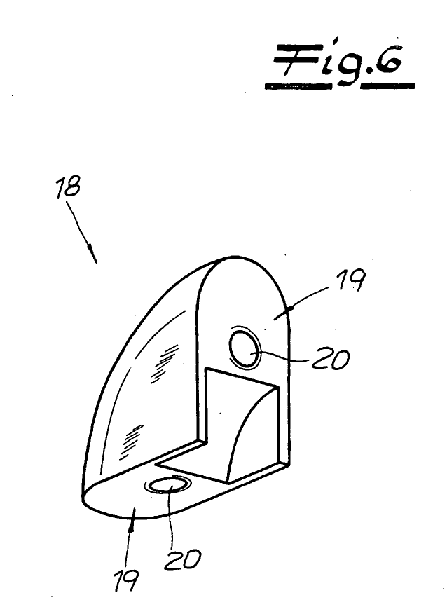

FIG. 5 plan view of a corner joint with two connection means according to the invention and

FIG. 6 perspective view of a corner joint according to FIG. 5

The figures show a connection means 1 for fixing a planar partitioning element, in particular and in the exemplary embodiment, for fixing a shower partition wall 2 made of glass to a wall 3. The connection means features a base element formed as base plate 4, with which a fixing surface 5 is fixed to the wall 3. Moreover, the connection means 1 feature a fixing element formed as a fixing plate 6, which stretches in transverse direction to the base plate 4 and can be fixed to the shower partition wall 2. The connection means 1 is also in the exemplary embodiment of an angle element comprising the base plate 4 and fixing plate 6, wherein preferably and in the exemplary embodiment the base plate 4 and fixing plate 6 include an angle of 90° between themselves.

In the base plate, a fastening opening 7 is provided for receiving a fixing element formed as a fixing screw 8. The base plate 4 or the connection means 1 is fixed to the wall 3 with the fixing screw 8. The fastening opening 7 provided in the base plate 4 is formed as a slotted hole in which the fixing screw 8 is held in a sliding manner preferably and in the exemplary embodiment. A first adjusting possibility is provided in this manner. Furthermore, in the base plate 4 is an adjustment opening 9 provided for receiving an adjusting element formed as an adjusting screw 10. The adjustment opening 9 features an internal thread into which the adjusting screw 10 can be screwed. In FIG. 1 and 3 it is especially apparent that a spacer 11 protrudes from the fixing surface 5 of the base plate 4, which ensures fixed spacing between the fixing surface 5 and the wall 3 in the section of spacer 11. In these figures it is preferably and in the exemplary embodiment therefore apparent that in the one half of the base plate 4 the adjustment opening 9 with the adjusting screw 10 is located and in the other half of the base plate 4 the spacer 11 is located. In FIG. 1 and 3 it is furthermore apparent that an area element 12 on the fixing surface 5 features an inclination adjacent to the spacer 11, so that an angle, for example 2°, is formed between the area element 12 and the vertical V. In other words, the angle between this area element 12 of the base plate 4 and the fixing surface 13 of the fixing plate 6 is smaller than 90°.

In FIG. 1 it is apparent that the connection means 1 according to the invention is provided for fixing a shower partition wall 2 to a wall 3, wherein the wall 3 features a certain inclination relative to the vertical V. Such an inclination can, for example, result from inaccurate tile-laying on the wall 3. Due to the design of the connection means 1 according to the invention, this inclination of the wall 3 can be precisely and reliably compensated for so that the shower partition wall 2 nevertheless can be aligned exactly perpendicularly to the vertical V. The fixed adjusting screw 10 particularly serves for compensation of the inclination or for adjustment in the adjustment opening 9, with which the spacing between the area element 12 and the wall 3 can be set reliably. In combination with this adjusting device (adjusting screw/adjustment opening) special importance is also given to the spacer 11 and the inclination of area element 12. Also essential in this connection is that the adjustment opening 9 is eccentrically located in the fixing surface 5. By screwing the adjusting screw 10 in the adjustment opening 9, the spacing between the wall 3 and the fixing surface 5 can be enlarged. If the adjusting screw 10 is turned in the opposite direction, the spacing can be reduced correspondingly.

Preferably and in the exemplary embodiment, a counter plate 14 is provided on the fixing plate 6, and fixing plate 6 and counter plate 14 are connected with one another to form a clamping holder of the shower partition wall 2. Fixing plate 6 and counter plate 14 are connected with one another by means of a screw in the exemplary embodiment. For this purpose, a fixing screw 15 is provided, which penetrates a slotted hole 16 in the fixing plate 6 as provided and can be screwed in the threads provided in the counter plate 14. The slotted hole 16 ensures a further adjusting possibility. Especially in FIG. 2, it is generally apparent that the fastening opening 7, the adjustment opening 9 and the slotted hole 16 can be covered by means of a single angular covering element 17, which can be adapted in a form-closed manner in a corresponding recess in connection means 1.

FIG. 5 and 6 show a corner joint 18 of the two connection surfaces 19, on which a connection means 1 according to the invention can be connected. The corner joint 18 furthermore features a fastening hole 20 on each connection surface 19 that is advantageously provided with an internal thread, in which the fixing screw 8 of a connection means 1 can be screwed. With the help of the adjustment possibilities of the connection means 1 according to the invention, a very reliable and exact, perpendicular alignment of the two connected shower partition walls 2 can be obtained. With the help of adjusting screw 10 of a connection means 1, the spacing between corner joint 18 and base plate 4 in the section around adjusting screw 10 can also be adjusted.

1. Connection means (1) for fixing planar partitioning elements to a wall (3), particularly for shower partitioning elements made of glass or plastic,
with a base element that can be fixed to the wall (3) with a fixing surface (5) and a fixing element that stretches transversely to the base element to which the planar partitioning element can be fixed,
wherein, at least one fastening opening (7) for holding a fixing element is provided in the base element, and
wherein, at least an adjustment opening (9) for receiving an adjusting element is provided in the base element, and the spacing of at least a part of the fixing surface (5) to the wall (3) can be adjusted with said adjusting element.

2. Connection means, according to claim 1, wherein the base element is formed as base plate (4) and the fastening opening (7) and the adjustment opening (9) penetrate the base plate (4).

3. Connection means, according to one of claim 1 or 2, wherein the fastening opening (7) is formed in the base element as a slotted hole, in which the fixing element is mounted in a sliding manner.

4. Connection means, according to one of claims 1 to 3, wherein the adjustment opening (9) is located eccentrically in the base element.

5. Connection means, according to one of claims 1 to 4, wherein the adjustment opening (9) features an internal thread that receives an adjusting element formed as an adjusting screw (10).

6. Connection means, according to one of claims 1 to 5, wherein a spacer (11) protrudes out of the fixing surface (5) of the base element, which ensures spacing between the fixing surface (5) and the wall (3) in the spacer (11) section.

7. Connection means, according to claim 6, wherein in one half of the base element the adjustment opening (9) with the adjusting element is located and in of the other half of the base element the spacer (11) is located.

8. Connection means, according to one of claims 1 to 7, wherein the fixing element is formed as a fixing plate (6), wherein a counter plate (14) is provided, and wherein a fixing plate (6) and counter plate (14) can be connected with one another as a clamping holder of a planar partitioning element.

9. Connection means, according to claim 8, wherein a fixing plate (6) and fixing plate (14) can be connected to one another via a screw connection and wherein at least one fixing screw (15) is provided for this purpose, which penetrates one of the two plates provided with a slotted hole (16) and can be screwed in a thread provided on the other plate.

10. Connection means, according to one of claims 1 to 9, wherein a single covering element (17) is provided with which the fastening opening (7), the adjustment opening (9) and the slotted hole (16) are coverable.
